(19) United States
(12) Patent Application Publication
(10) Pub. No.: US 2021/0190517 A1
(43) Pub. Date: Jun. 24, 2021

(54) ROUTE EVALUATION APPARATUS

(71) Applicant: Honda Motor Co., Ltd., Tokyo (JP)

(72) Inventor: Takahiro Oyama, Tokyo (JP)

(21) Appl. No.: 17/269,525

(22) PCT Filed: Aug. 23, 2019
(86) PCT No.: PCT/JP2019/032946

§ 371 Date: Feb. 18, 2021

(30) Foreign Application Priority Data
Aug. 31, 2018 (JP) 2018-163279

(51) Int. Cl. G01C 21/34; G06F 3/0481; G06Q 10/04; G06Q 10/06

(52) U.S. Cl. CPC G01C 21/3453; G06Q 10/06395; G06Q 10/047; G06F 3/04817

(57) ABSTRACT

A route-evaluation-apparatus evaluating a route of a worker: including a microprocessor and memory. The microprocessor functions as: an information-acquisition-unit acquiring location-information of the worker calculated based on GPS-signals, and acquiring time-information about when the location-information is calculated. The route-evaluation-apparatus further includes: a display-unit displaying plotted-points corresponding to the location information, and an icon-placement-unit placing a first icon and second icon on the travel route. The microprocessor functions as: a start-point/end-point-selection-unit selecting an end-point corresponding to the second-icon, and a required-time-calculation-unit calculating a required-time-period for a section from the start-point to the end-point. The travel-route sequentially passes through predetermined-areas in a predetermined-passing-order. The icon-placement-unit places the first-icons on each entering-points of the predetermined-areas, and place the second-icons on each exiting-points of the predetermined-areas. The required-time-calculation-unit calculates the required-time-period for each of the sections corresponding to the predetermined-areas.

### CROSS-REFERENCE TO RELATED APPLICATION

This application is a National Stage of PCT international application Ser. No. PCT/JP2019/032946 filed on Aug. 23, 2019 which designates the United States, incorporated herein by reference, and which is based upon and claims the benefit of priority from Japanese Patent Application No. 2018-163279, filed on Aug. 31, 2018, the entire contents of which are incorporated herein by reference.

### TECHNICAL FIELD

This invention relates to a route evaluation apparatus for evaluating travel routes.

### BACKGROUND ART

As this type of technique, conventionally, there have been known a device configured to grasp position of a user at any time based on positional information and time information derived from GPS signals received by a GPS receiver of a user terminal (e.g., see Patent Document 1). In the device disclosed in Patent Document 1, a travel route in a specific period is estimated based on a plurality of pieces of position information and time information in the specific period.

### CITATION LIST

### Patent Literature

Patent Document 1: Japanese Unexamined Patent Publication No. 2012-208882

### DISCLOSURE OF INVENTION

### Problems to be Solved by the Invention

However, since the device described in Patent Document 1 does not specify a specific section on the travel route and calculate the required time period, it is difficult to evaluate the travel route.

### Means for Solving Problem

An aspect of the present invention is a route evaluation apparatus configured to evaluate a travel route of a worker who conducts business or work. The route evaluation apparatus includes: an information acquisition unit configured to acquire location information of the worker calculated based on GPS signals received by a GPS receiver provided on a mobile terminal carried by the worker or provided on a mobile body driven by the worker, and configured to acquire time information about when the location information is calculated; a display unit configured to display a plurality of plotted points corresponding to the location information based on the location information and the time information acquired by the information acquisition unit; an icon placement unit configured to place a first icon and second icon on the travel route connecting plotted points next to each other in timing from among the plurality of plotted points displayed by the display unit; a start point/end point selection unit configured to select a start point corresponding to the first icon placed by the icon placement unit, and configured to select an end point corresponding to the second icon placed by the icon placement unit from among the plurality of plotted points; and a required time calculation unit configured to calculate a required time period for a section from the start point to the end point selected by the start point/end point selection unit. The travel route sequentially passes through a plurality of predetermined areas in a predetermined passing order. The icon placement unit is configured to place a plurality of the first icon on each entering points of the plurality of predetermined areas, and is configured to place a plurality of the second icon on each exiting points of the plurality of predetermined areas. The required time calculation unit is configured to calculate the required time period for each of a plurality of the section corresponding to the plurality of predetermined areas.

### Effect of the Invention

According to the present invention, it becomes possible to specify a specific section on the travel route, calculate the required time period, and evaluate the travel route.

### BRIEF DESCRIPTION OF DRAWINGS

FIG. 1 is a diagram showing an example of the system configuration of a management system including a route evaluation apparatus according to an embodiment of the present invention.

FIG. 2 is a block diagram showing a schematic configuration of a delivery worker terminal in FIG. 1.

FIG. 3 is a block diagram showing a schematic configuration of a management server in FIG. 1.

FIG. 4 is a diagram showing a scheduled route and an actual route.

FIG. 5 is a diagram showing setting of sections.

FIG. 6A is a diagram showing an example of selection of a start point and an end point of the section.

FIG. 6B is a diagram showing another example of selection of a start point and an end point of the section.

FIG. 7 is a flowchart showing an example of a process performed by the management server in FIG. 3.

FIG. 8 is a block diagram showing a schematic configuration of a manager terminal in FIG. 1.

FIG. 9 is a diagram showing placement of a cut icon for specifying the start point and the end point of the section.

FIG. 10A is an example of a setting screen for setting position of the cut icon.

FIG. 10B is an example of the setting screen for setting position of the cut icon, following FIG. 10A.

FIG. 11 is an example of a route evaluation screen showing route evaluation information.

FIG. 12 is an example of analysis results of route evaluation information.

FIG. 13 is a comparative example of dividing the actual route using mesh areas.

FIG. 14 is a drawing showing time measurement when passing through a specific block plural times.

### DESCRIPTION OF EMBODIMENT

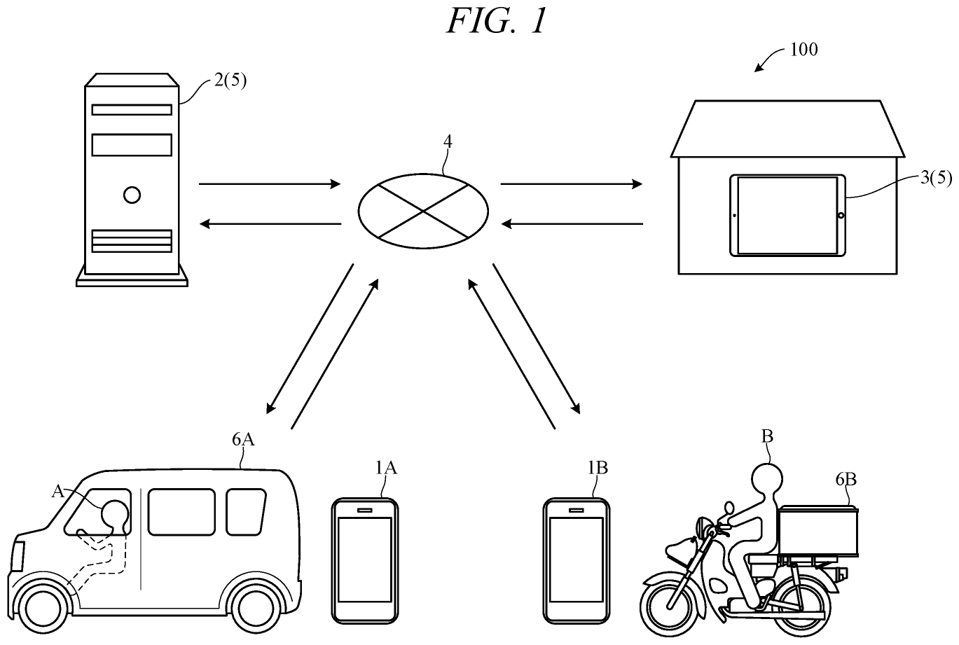

Now, an embodiment of the present invention will be described with reference to FIGS. 1 to 14. A route evaluation apparatus according to the embodiment of the present invention can be applied to management systems that manage workers in charge of work in assigned areas, in various industries. Hereafter, an example will be described in which the route evaluation apparatus is applied to a management system that manages delivery workers who deliver cargos, flyers, mail pieces such as letters and postcards, or the like. That is, an example will be described in which delivery workers in charge of delivery work at the distribution center of a distribution business, post office, or the like are regarded as workers in charge.

To allow the delivery workers to efficiently perform such delivery work, it is common to sort cargos, flyers, mail pieces such as letters or postcards, or the like into predetermined areas (blocks) at the distribution center and to cause the delivery workers to deliver the cargos or the like to the blocks assigned to the delivery workers through predetermined routes. While the delivery workers perform such delivery work through the predetermined scheduled routes, they may actually perform such delivery work through routes different from the scheduled routes on the basis of their know-how. To grasp the actual state of such delivery work and use the actual state to set optimum scheduled routes, the route evaluation apparatus according to the present embodiment is configured to be able to evaluate the travel routes of the delivery workers in terms of the required time period and work efficiency as follows.

### [Functional Configuration of Management System 100]

First, the functional configuration of a management system 100 according to the embodiment of the present invention will be described. FIG. 1 is a diagram showing an example of the system configuration of the management system 100. As shown in FIG. 1, the management system 100 includes multiple (two in FIG. 1) delivery worker terminals 1A and 1B, a management server 2, and a manager terminal 3 that are connected through a network 4, including a public wireless communication network typified by the Internet network, mobile phone network, or the like. In the management system 100 thus configured, the management server 2 and manager terminal 3 form a route evaluation apparatus 5 according to the embodiment of the present invention. The management server 2 or manager terminal 3 alone may form the route evaluation apparatus 5. The network 4 also includes a closed communication network provided in a predetermined control area, such as a wireless LAN and Wi-Fi® (Wireless Fidelity).

The delivery worker terminals 1A and 1B are held in clothes pockets, bags, pouches, or the like of the delivery workers A and B, or disposed in the cradles or the like of vehicles 6A and 6B used for delivery work. In the present embodiment, smartphones or tablet terminals, mobile phones, personal digital assistants (PDAs), and various types of wearable terminals that are connectable to a public wireless communication network are collectively referred to as the delivery worker terminals 1A and 1B. The delivery worker terminals 1A and 1B have the same configuration. The number of delivery worker terminals may be three or more. The vehicles 6A and 6B are transportation vehicles, such as four-wheeled vehicles, motorcycles, bicycles, or carts. FIG. 1 shows a light truck (e.g., a truck having a predetermined displacement or less) 6A, which is widely being used to deliver cargoes, flyers, mail pieces such as letters and postcards, or the like, and a motorized bicycle (e.g., a motorcycle including a motor having a predetermined displacement or less) 6B as an example. The delivery workers A and B may perform delivery work on foot without using the vehicle 6A or 6B.

Next, the configuration of the delivery worker terminals 1A and 1B, management server 2, and manager terminal 3 will be described.

### <Delivery Worker Terminals 1A and 1B>

First, the delivery worker terminals 1A and 1B will be described. Various types of application software can be installed on the delivery worker terminals 1A and 1B. The delivery worker terminals 1A and 1B form a part of the management system in accordance with application software installed on smartphones. By using commercially available smartphones, the system construction cost can be suppressed.

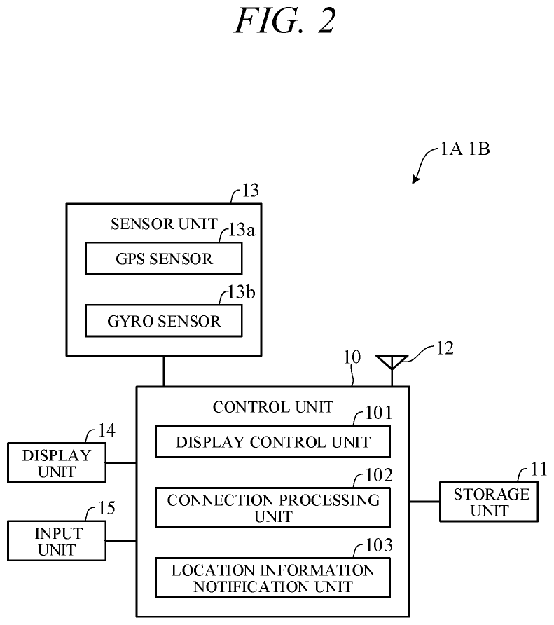

FIG. 2 is a block diagram showing a schematic configuration of the delivery worker terminals 1A and 1B. As shown in FIG. 2, the delivery worker terminal 1A includes a control unit 10, a storage unit 11, a wireless unit 12, a sensor unit 13, a display unit 14, and an input unit 15.

The storage unit 11 consists of a semiconductor memory, hard disk, or the like. The storage unit 11 stores software, including an operating system (OS) and application programs for supporting delivery work, and various types of information, including map information such as road maps and residential maps and customer information about delivery destinations. The customer information includes the addresses and phone numbers of the delivery destinations, as well as customer-related information, such as whether the customers have delivery boxes. The software, map information, and customer information may be previously stored in the storage unit 11, or acquired from the management server 2.

The wireless unit 12 includes a digital signal processor (DSP) and the like and is configured to be able to wirelessly communicate with the management server 2 through a wireless communication network typified by a mobile phone network, such as 3G, LTE, 4G, or 5G. The wireless unit 12 may include a near-field wireless communication unit (not shown) capable of using a near-field wireless communication technology, such as Wi-Fi® or Bluetooth®. The wireless unit 12 is able to transmit a login ID for identifying the delivery worker A or B (“delivery worker ID”), information on the current location of the delivery worker A or B or vehicle 6A or 6B, speed information, and the like to the management server 2.

The sensor unit 13 includes a GPS sensor 13a that receives locating signals from multiple GPS satellites and measures the absolute location (latitude, longitude) of the delivery worker A or B corresponding to the delivery worker terminal 1A or 1B, a gyro sensor 13b that detects the angular velocity, and the like. If it is difficult to receive locating signals from the GPS satellites, the current location of the delivery worker A or B or vehicle 6A or 6B may be calculated using Assisted Global Positioning System (AGPS) communication on the basis of information on the base stations of the wireless communication network acquired from the wireless unit 12.

The display unit 14 consists of a display device, such as a liquid crystal display or organic EL panel. The display unit 14 receives an instruction from the control unit 10 and displays a map, a button icon for operating a touchscreen, or the like. The display unit 14 is also able to display various types of information, such as the current location of the delivery worker A or B or vehicle 6A or 6B, a map around the current location, and a map around the delivery destination.

The input unit 15 consists of a physical switch, such as a numeric keypad, operated by the delivery worker A or B, an input device (not shown), such as a touchscreen, disposed so as to be overlaid on the display surface of the display unit 14, or the like. The input unit 15 outputs a signal based on operation input, such as depression of the numeric keypad or touchscreen by the delivery worker A or B, to the control unit 10. Thus, for example, the screen display of the display unit 14 is changed.

Although not shown, the delivery worker terminals 1A and 1B may further include a speaker, vibrator, light, microphone, or the like. The speaker, vibrator, or light notifies the delivery worker of various types of information through a sound, vibration, or light. The speaker outputs a sound to the delivery worker, and the microphone collects a sound or the like issued from the delivery worker. Thus, the delivery worker terminals 1A and 1B are able to output various types of information from the speaker in the form of sounds and to input various types of commands inputted in the form of sounds through the microphone by the delivery worker to the control unit 10 using a sound recognition technology.

The control unit 10 includes a microprocessor including a CPU, RAM, ROM, I/O, and the like. The CPU executes a previously stored program and transmits and receives signals to and from the storage unit 11, wireless unit 12, sensor unit 13, display unit 14, and input unit 15. The control unit 10 includes, as functional elements, a display control unit 101, a connection processing unit 102, and a location information notification unit 103.

The display control unit 101 controls the screen display of the display unit 14 by generating image signals in response to an operation on the input unit 15 or in response to the wireless unit 12 receiving various types of information and transmitting the image signals to the display unit 14. Screens that the display control unit 101 causes the display unit 14 to display include a login screen for logging in to the management system 100, and the like.

The connection processing unit 102 transmits, to the management server 2 through the wireless unit 12, a login ID and a password inputted by the delivery worker A or B on the login screen displayed on the display unit 14 through the input unit 15. Thus, the delivery worker terminal 1A or 1B is communicatively connected to the management server 2. The delivery worker performs this login input when starting to work, that is, when departing from the distribution center. Also, when logout is inputted through the input unit 15, the connection processing unit 102 transmits the logout to the management server 2 through the wireless unit 12. Thus, the communication connection between the delivery worker terminal 1A or 1B and management server 2 is complete. The delivery worker performs this logout input when finishing work, that is, when returning to the distribution center. Logout may be automatically performed on the basis of the time or location information when the delivery worker returns to the distribution center.

The location information notification unit 103 transmits information on the current location of the delivery worker A or B or vehicle 6A or 6B traveling with the delivery worker terminal 1A or 1B calculated on the basis of GPS signals received by the sensor unit 13 (GPS sensor 13a), current time information acquired from a clocking unit (not shown), and the like to the management server 2 through the wireless unit 12 at predetermined time intervals (e.g., at intervals of 1 s) such that these pieces of information are associated with the delivery worker ID. The current time information includes not only the time but also the year, month, day, and the like.

The positions of the delivery workers A and B or vehicles 6A and 6B change from moment to moment. For this reason, when current location information is acquired at predetermined time intervals, the location obtained from the latest current location information and the actual location may not exactly match each other. However, the deviation is small and therefore the location obtained from current location information acquired at predetermined time intervals can be considered as the current location. Multiple pieces of information, such as information on the current location of the delivery worker A or B or vehicle 6A or 6B acquired at predetermined time intervals and current time information, may be collectively transmitted at once (so-called “burst transmission”). The time intervals at which information on the current location of the delivery worker or vehicle, and the like are acquired (e.g., intervals of 1 s), the number of pieces of information transmitted at once when burst-transmitting multiple pieces of information collectively, or the like may be previously set.

### <Management Server 2>

Next, the management server 2 will be described. While, in the present embodiment, the management server 2 will be described as a single server having various functions, it may be a distributed server consisting of servers having different functions or may be realized by a cloud server (virtual server).

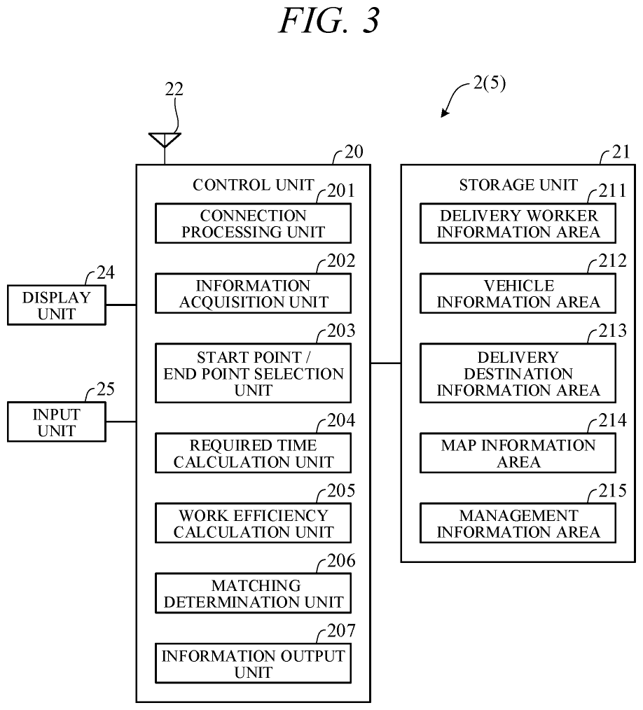

FIG. 3 is a block diagram showing a schematic configuration of the management server 2. As shown in FIG. 3, the management server 2 includes a control unit 20, a storage unit 21, a communication unit 22, a display unit 24, and an input unit 25. The display unit 24 and input unit 25 may be omitted or may consist of other information terminals (not shown) connected to the management server 2.

The storage unit 21 consists of a semiconductor memory, hard disk drive, or the like. The storage unit 21 stores software, such as an operating system (OS) and applications, and other various types of information. For this reason, various storage areas, such as a delivery worker information area 211, a vehicle information area 212, a delivery destination information area 213, a map information area 214, and a management information area 215, are ensured in the storage unit 21. An information area is, for example, a table in a database management system, or the like.

The delivery worker information area 211 is an information area in which delivery worker information used to manage each delivery worker, such as the name of the delivery worker and the ID of the center to which the delivery worker belongs, is stored so as to be associated with the employee ID of the delivery worker (also referred to as the delivery worker ID), which is identification information of the delivery worker. A vehicle ID, which is identification information of a vehicle used by each delivery worker, that is, the vehicle 6A or 6B, is also stored in the delivery worker information area 211 so as to be associated with the delivery worker ID. For example, the manager of the distribution center sets the association of the vehicle IDs with the delivery worker IDs before daily delivery work is started.

The vehicle information area 212 is an information area in which information on each vehicle, including the vehicle type, such as four-wheeled vehicle, motorcycle, or bicycle, and the size of the cargo room, is stored so as to be associated with the vehicle ID.

The delivery destination information area 213 is an information area storing delivery destination information, such as the addresses (latitudes, longitudes) and phone numbers of the delivery destinations, blocks including the delivery destinations, and the delivery workers A and B in charge of the blocks including the delivery destinations. The blocks are areas previously set by the manager of the distribution center to sort delivery work. For example, each block corresponds to one or more city blocks and consists of delivery destinations consisting of 10 to 30 households. The delivery workers A and B are in charge of assigned areas each consisting of multiple blocks.

The map information area 214 is an information area in which map information is previously stored. The map information includes road link information, map data for displaying the background, such as roads and road maps, and the like. Such map information is updated periodically.

The management information area 215 is an information area storing information on the scheduled routes of the delivery workers A and B previously set by the manager of the distribution center, the amount of work in each block, the time-series locations of the delivery workers A and B or vehicles 6A and 6B acquired from the delivery worker terminals 1A and 1B, and sections set by the manager of the distribution center. The amount of work in each block refers to the amount of cargos, flyers, mail pieces such as letters and postcards, or the like delivered. As the amount of work in each block, the number of delivery households in each block is previously set on the basis of the map information, customer information, and the like, or the number of actually delivered cargos, flyers, mail pieces such as letters and postcards, or the like is set through the manager terminal 3 or the like.

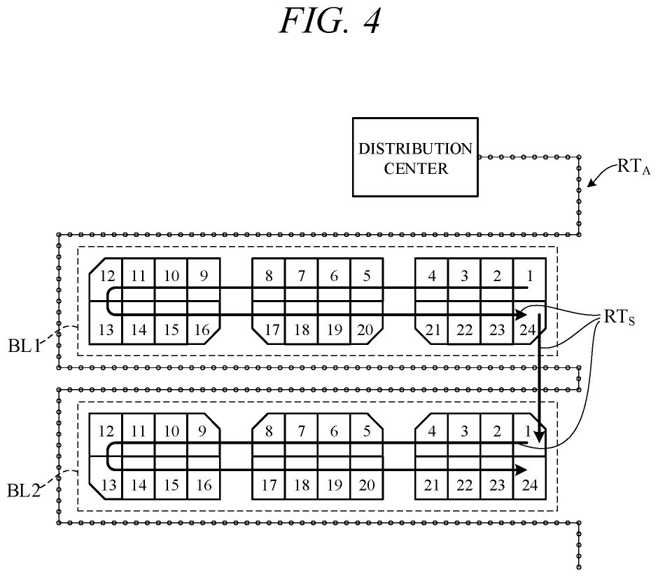

FIG. 4 is a diagram showing a scheduled route RTS and an actual route RTA. As shown in FIG. 4, for example, the order in which a delivery worker, for example, the delivery worker A, passes through assigned blocks BL1 and BL2 (BL1→BL2 and the like in FIG. 4) and the order in which the delivery worker A passes through delivery destinations in the blocks BL1 and BL2 (1→2 and the like in FIG. 4) are previously set as the scheduled route RTS of the delivery worker A. Information on the scheduled route RTS is transmitted to the manager terminal 3 of the distribution center and displayed on a map. The manager is able to use this information to arrange cargos, flyers, mail pieces such as letters and postcards, or the like to be delivered by the delivery worker A, in the order of delivery at the distribution center. The information on the scheduled route RTS may be transmitted to a sorter or the like of the distribution center so that cargos, flyers, mail pieces such as letters and postcards, or the like are automatically arranged in the order of delivery.

Information on the time-series locations of the delivery workers A and B or vehicles 6A and 6B acquired from the delivery worker terminals 1A and 1B is also transmitted to the manager terminal 3 and displayed on a map. For example, the location of the delivery worker A is displayed as a plotted point at predetermined time intervals. A line obtained by connecting the plotted points corresponding to the locations of the delivery worker A on a time-series basis is displayed as the actual route RTA of the delivery worker A. For example, the adjacent plotted points are connected by straight lines on a time-series basis.

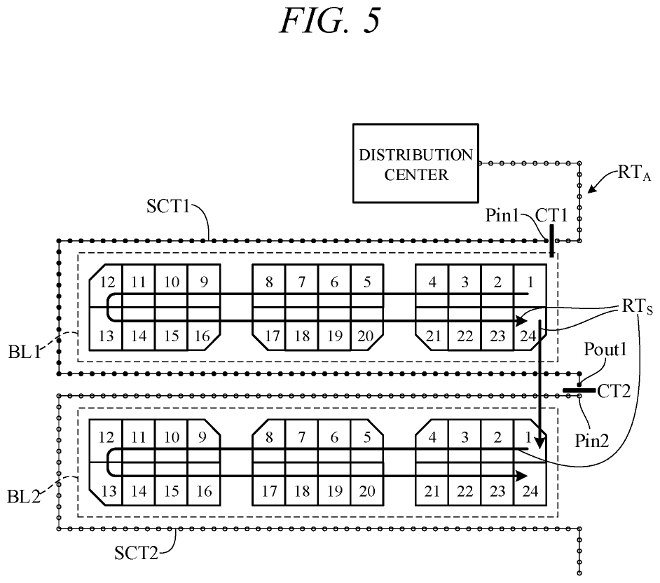

FIG. 5 is a diagram showing setting of sections. The manager of the distribution center sets sections SCT1 and SCT2 corresponding to the blocks BL1 and BL2 on the actual route RTA displayed on the manager terminal 3 along the scheduled route RTS, that is, in the previously set order of passage. For example, when setting the section SCT1 corresponding to the block BL1, the manager places a cut icon CT1 specifying the start point of the section SCT1 and a cut icon CT2 specifying the end point thereof, as shown in FIG. 5.

The cut icons CT (CT1, CT2) are placed as line-segment icons or rectangular icons, and the display positions, display directions, and sizes (lengths) thereof on a map are determined in accordance with operations performed on the icons by the manager. The cut icons CT are placed with a length corresponding to the road width so as to intersect the actual route RTA, for example, so as to be perpendicular to the actual route RTA. The cut icons CT may be points, circles around points, or areas (geofences) inside polygons. By placing the cut icons CT1 and CT2, a section from a plotted start point Pin1 immediately behind the cut icon CT1 to a plotted end point Pout1 immediately before the cut icon CT2, of the actual route RTA is set as a section SCT1. The section SCT1 is highlighted, for example, by differentiating the color, shape, or size of the plotted points thereof from that of the plots of the other sections. In this way, the manager is able to specify the desired section SCT1 with an intuitive operation as if the manager cut the section SCT1 from the actual route RTA displayed on the manager terminal 3 using scissors.

Information on the positions of the cut icons CT specifying the start points and end points of the sections SCT1 and SCT2 (information on the display positions on the map) is stored in the management information area 215 for each of the sections SCT1 and SCT2 as section information. The information on the positions of the cut icons CT specifying the sections SCT1 and SCT2 can be read and used. For example, when setting the section SCT2 corresponding to the block BL2, which is a block immediately after the block BL1 in the order of delivery, the start point of the block BL2 can be specified by the cut icon CT2 specifying the end point of the immediately preceding block BL1, as shown in FIG. 5. The sections SCT1 and SCT2 corresponding to the blocks BL1 and BL2 may also be set on an actual route RTA on a different day of the week or in a different time slot on the basis of information on the positions of the cut icons CT specifying the sections SCT1 and SCT2 stored in the management information area 215.

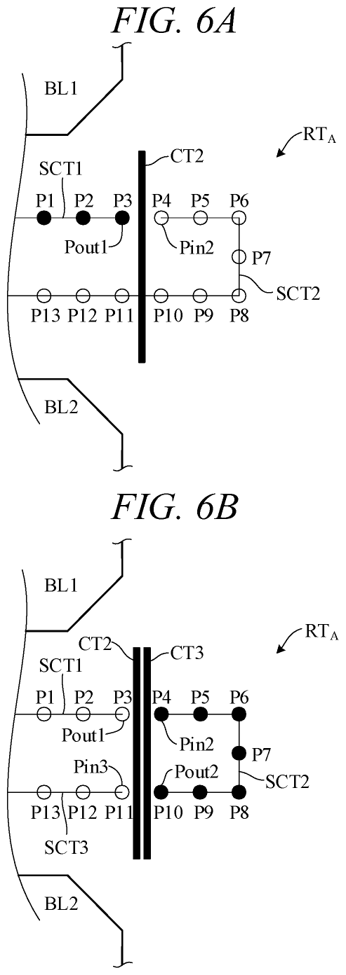

FIGS. 6A and 6B are diagrams showing selection of the start points and end points of the sections SCT2 and SCT3 following the section SCT1 with the start point of the section SCT1 specified by the cut icon CT1 and show the time-series locations of the delivery worker A or B as plotted points P1 to P13. The cut icon CT2 of FIGS. 6A and 6B specifies the plotted end point Pout1 of the section SCT1, as well as specifies the plotted start point Pin2 of the section SCT2 following the section SCT1. A cut icon CT3 of FIG. 6B specifies the plotted end point Pout2 of the section SCT2, as well as specifies the plotted start point Pin3 of a section SCT3 following the section SCT2. As shown in FIGS. 6A and 6B, when the delivery worker A or B makes a round trip on the same place, for example, on the same road, the actual route RTA may pass through the cut icons CT multiple times.

In an example in FIG. 6A, the plotted end point Pout1 of the section SCT1 and the plotted start point Pin2 of the section SCT2 following the section SCT1 are specified by the cut icon CT2. As shown in FIG. 6A, the actual route RTA including the plotted points P1 to P13 first passes through the cut icon CT2 between the plotted points P3 and P4 and then again passes through the cut icon CT2 between the plotted points P10 and P11.

In this case, the actual route RTA is divided into the sections SCT1 and SCT2 between the plotted points P3 and P4, between which the actual route RTA first passes through the cut icon CT2 on a time-series basis. That is, the plotted point P3 is specified as the plotted end point Pout1 immediately before the cut icon CT2 (as the end point of the section SCT1), and the plotted point P4 is specified as the plotted start point Pin2 immediately behind the cut icon CT2 (as the start point of the section SCT2 following the section SCT1). Thus, a section up to the plotted point P3 of the actual route RTA is set as the section SCT1 and highlighted. The confirmed section SCT1 is regarded as having been cut from the actual route RTA and is not considered when setting the sections SCT2 and SCT3 subsequently.

In an example in FIG. 6B, the plotted end point Pout2 of the section SCT2 following the set section SCT1 and the plotted start point Pin3 of the section SCT3 following the section SCT2 are specified by the cut icon CT3. As shown in FIG. 6B, the actual route RTA including the plotted points P4 to P13, from which the set section SCT1 has been cut, passes through the cut icon CT3 between the plotted points P10 and P11. Thus, the actual route RTA is divided into the sections SCT2 and SCT3 between the plotted points P10 and P11, and the plotted point P10 immediately before the cut icon CT3 is specified as the plotted end point Pout2 of the section SCT2, and the plotted point P11 immediately behind the cut icon CT3 is specified as the plotted start point Pin3 of the section SCT3.

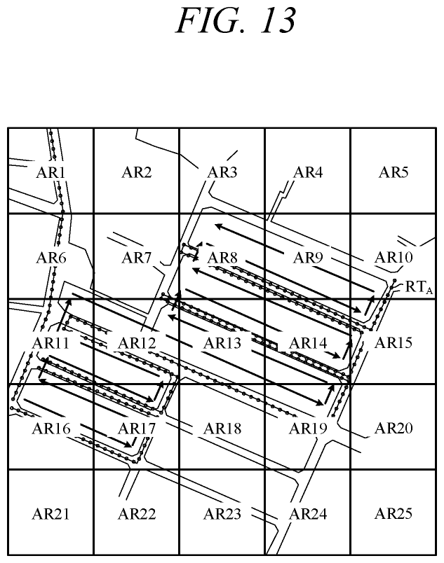

In this way, the manager is able to divide the actual route RTA obtained by connecting the time-series plotted multiple points displayed on the manager terminal 3, into desired sections with an intuitive operation as if the manager cut the sections from the actual route RTA sequentially from one end to another using scissors. Even if the actual route RTA makes a round trip on the same place, the manager is able to divide the actual route RTA into multiple sections in the order of passage on a time-series basis. Note that, for example, a technique of dividing the actual route RTA using mesh areas AR1 to AR25 corresponding to the latitude and longitude, as shown in FIG. 13, is also conceivable. However, such a technique has difficulty in dividing the actual route RTA into multiple sections in the order of passage on a time-series basis.

The communication unit 22 implements a communication protocol enabling wireless communication, such as 3G, LTE, 4G, or 5G, to communicate with the delivery worker terminals 1A and 1B. On the other hand, the communication unit 22 implements a communication protocol enabling wired communication (e.g., Internet line or the like) or wireless communication to communicate with the manager terminal 3.

The control unit 20 includes a processor including a CPU, RAM, ROM, I/O, and the like. The control unit 20 includes, as functional elements, a connection processing unit 201, an information acquisition unit 202, a start point/end point selection unit 203, a required time calculation unit 204, a work efficiency calculation unit 205, a matching determination unit 206, and an information output unit 207.

The connection processing unit 201 processes login from the delivery worker terminal 1A or 1B and connects the delivery worker terminal 1A or 1B to the management server 2. The connection processing unit 201 also processes logout from the delivery worker terminal 1A or 1B and completes the connection between the delivery worker terminal 1A or 1B and the management server 2. The connection processing unit 201 also processes login from the manager terminal 3 and connects the manager terminal 3 to the management server 2, as well as processes logout from the manager terminal 3 and completes the connection between the manager terminal 3 and management server 2.

The information acquisition unit 202 acquires various types of information by receiving data transmitted from the delivery worker terminals 1A and 1B to the management server 2 and data transmitted from the manager terminal 3 to the management server 2, through the communication unit 22. The information acquired by the information acquisition unit 202 includes information on the locations of the vehicles 6A and 6B transmitted from the location information notification units 103 of the delivery worker terminals 1A and 1B and time information corresponding to the location information, information on the scheduled routes and sections of the delivery workers A and B transmitted from the manager terminal 3, and the like. Specifically, the location information is represented by the latitude and longitude.

The start point/end point selection unit 203 selects the start points and end points of the sections SCT1 and SCT2 corresponding to the blocks BL1 and BL2 on the basis of section information stored in the management information area 215, that is, information on the locations of the cut icons CT specifying the start points and end points of the sections SCT1 and SCT2. Specifically, the start point/end point selection unit 203 selects a plotted point immediately behind each cut icon CT as the plotted start point Pin of the following section from among the time-series plotted multiple points forming the actual route RTA, as well as selects a plotted point immediately before the cut icon CT as the plotted end point Pout of the preceding section from thereamong.

The required time calculation unit 204 calculates the required time periods in the blocks BL1 and BL2 on the basis of information on the time-series locations of the delivery workers A and B or vehicles 6A and 6B stored in the management information area 215. That is, the required time calculation unit 204 calculates the required time periods in the blocks BL1 and BL2 on the basis of information on the times of the plotted start points Pin and information on the times of the plotted end points Pout selected by the start point/end point selection unit 203. For example, when calculating the required time period in the block BL1, the required time calculation unit 204 calculates the required time period in the section SCT1 corresponding to the block BL1 on the basis of information on the times of the plotted start point Pin1 and plotted end point Pout1 of the section SCT1, as shown in FIG. 5. Information on the required time periods in the blocks BL1 and BL2 is transmitted to the manager terminal 3 of the distribution center as route evaluation information. The manager of the distribution center is able to evaluate the actual route RTA by checking the required time periods in the blocks BL1 and BL2 through the manager terminal 3. Thus, for example, the manager is able to divide a block having a long required time period into multiple blocks and assign the blocks to multiple delivery workers. The manager is also able to review the delivery workers in charge of the respective blocks or review the scheduled routes on a day-of-the-week or time-slot basis by making a comparison between the required time periods on the actual routes RTA that differ in delivery worker, day of the week, time slot, or the like.

The work efficiency calculation unit 205 calculates the work efficiency in each of the blocks BL1 and BL2 on the basis of information on the required time periods in the blocks BL1 and BL2 calculated by the required time calculation unit 204 and information on the amounts of work in the blocks BL1 and BL2 stored in the management information area 215. For example, if the required time period in the block BL1 is 4 min and the number of delivery destination households of 24 in the block BL1 is registered as the amount of work, the work efficiency is calculated as 6 households/min. If the number of flyers or mail pieces of 24 actually delivered in the block BL1 is registered as the amount of work, the work efficiency is calculated as 6 pieces/min. Information on the work efficiency in each of the blocks BL1 and BL2 is also transmitted to the manager terminal 3 as route evaluation information. The manager of the distribution center is able to evaluate the actual route RTA by checking the work efficiency in each of the blocks BL1 and BL2.

The matching determination unit 206 determines whether the scheduled route RTS and actual route RTA match each other, on the basis of information on the scheduled route RTS of the delivery worker A or B stored in the management information area 215 and information on the time-series locations of the delivery worker A or B or vehicle 6A or 6B. Specifically, the matching determination unit 206 determines whether the actual route RTA passes through the cut icons CT specifying the start points and end points of the sections corresponding to the respective blocks in the scheduled order. Information on the determination as to whether the scheduled route RTS and actual route RTA match each other is also transmitted to the manager terminal 3 of the distribution center as route evaluation information. The manager of the distribution center is able to evaluate the scheduled route RTS by checking whether the scheduled route RTS and actual route RTA match each other. That is, if it is determined that the scheduled route RTS and actual route RTA do not match each other and the delivery worker is actually selecting a delivery route different from the scheduled route RTS, there may be a rational reason. If so, the manager is able to review the scheduled route RTS.

The information output unit 207 outputs various types of information by transmitting data from the management server 2 to the manager terminal 3 through the communication unit 22. The information outputted by the information output unit 207 includes the required time periods and work efficiency in the blocks BL1 and BL2, the determination as to whether the scheduled route RTS and actual route RTA match each other, and the like.

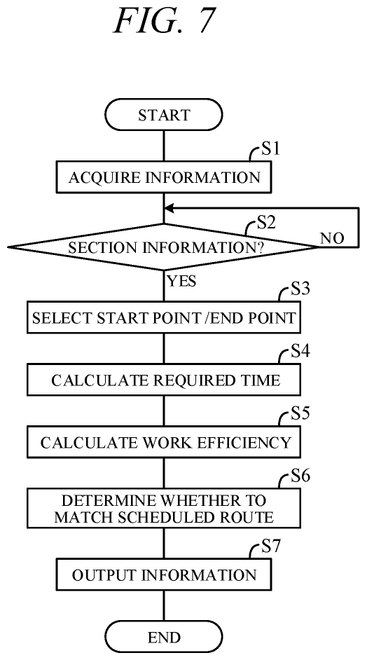

FIG. 7 is a flowchart showing an example of a process performed by the CPU of the management server 2 in accordance with a previously stored program. The process shown by this flowchart is started, for example, when the management server 2 receives a route evaluation information output request from the manager terminal 3.

First, in step S1, the information acquisition unit 202 reads the route evaluation information output request received from the manager terminal 3 through the communication unit 22 and reads information on the time-series locations of the specified delivery worker A or B in a specified delivery period. Then, in step S2, the information acquisition unit 202 determines whether information on the sections corresponding to the blocks assigned to the specified delivery worker A or B is stored in the management information area 215. Step S2 is repeated until the determination becomes YES.

If the determination in step S2 is YES, the process proceeds to step S3. The start point/end point selection unit 203 selects the plotted start points Pin and plotted end points Pout of the sections SCT1 and SCT2 corresponding to the blocks BL1 and BL2. Then, in step S4, the required time calculation unit 204 calculates the required time periods in the blocks BL1 and BL2. Then, in step S5, the work efficiency calculation unit 205 calculates the work efficiency in each of the blocks BL1 and BL2 on the basis of the required time periods calculated in step S4 and information on the amounts of work stored in the management information area 215. Then, in step S6, the matching determination unit 206 determines whether the scheduled route RTS and actual route RTA match each other, on the basis of the information on the scheduled route RTS and time-series locations stored in the management information area 215. Then, in step S7, the information output unit 207 transmits, to the manager terminal 3, route evaluation information including the required time periods and work efficiency in the blocks BL1 and BL2 and the determination as to whether the scheduled route RTS and actual route RTA match each other calculated in steps S4 to S6.

The manager of the distribution center is able to check the required time periods and work efficiency in the blocks BL1 and BL2 and whether the scheduled route RTS and actual route RTA match each other, through the manager terminal 3. Thus, the management is able to evaluate the travel routes of the delivery worker A or B, that is, the actual route RTA and scheduled route RTS thereof and to review the ranges of the blocks, the delivery worker in charge of the blocks, the scheduled route, and the like in accordance with the evaluation.

### <Manager Terminal 3>

Next, the manager terminal 3 will be described. The manager of the distribution center uses the manager terminal 3 to check and evaluate the travel routes of the delivery workers A and B. The manager terminal 3 is any type of computer, such as a personal computer, tablet terminal, or smartphone, disposed in the distribution center and transmits and receives information to and from the management server 2 through the network 4.

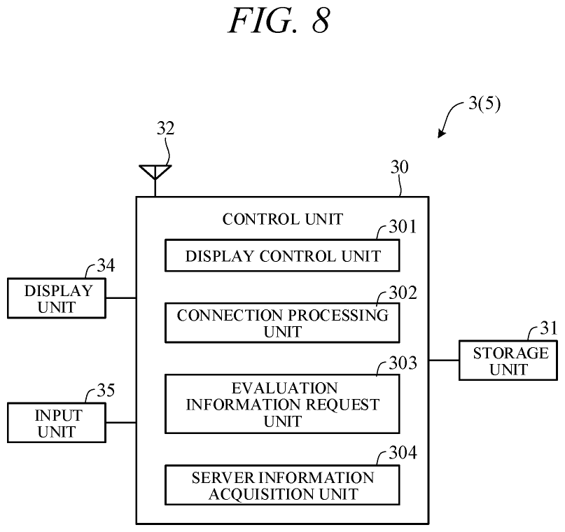

FIG. 8 is a block diagram showing a schematic configuration of the manager terminal 3. As shown in FIG. 8, the manager terminal 3 includes a control unit 30, a storage unit 31, a communication unit 32, a display unit 34, and an input unit 35.

The storage unit 31 consists of a semiconductor memory, hard disk drive, or the like. The storage unit 31 stores software, such as an operating system (OS) and applications, and other various types of information.

The communication unit 32 implements a communication protocol enabling wired communication (e.g., the Internet line or the like) or a communication protocol enabling wireless communication, such as 3G, LTE, 4G, or 5G, and is connected to the management server 2 to transmit and receive various types of data to and from the management server 2.

The display unit 34 consists of a display device, such as a liquid crystal display or organic EL panel. Upon receipt of an instruction from the control unit 30, the display unit 34 displays a map, a button icon for operating a touchscreen, or the like. The display unit 34 also displays route evaluation information or the like transmitted from the information output unit 207 of the management server 2.

The input unit 35 consists of physical switches, such as a numeric keypad, operated by the manager, an input device (not shown), such as a touchscreen, disposed so as to be overlaid on the display surface of the display unit 34, or the like. The manager inputs, through the input unit 35, a command to change the display screen of the display unit 34. The manager is able to set, through the input unit 35, the scheduled routes RTS of the delivery workers A and B, the amounts of work in the blocks BL1 and BL2, and the positions of the cut icons CT specifying the start points and end points of the sections SCT1 and SCT2.

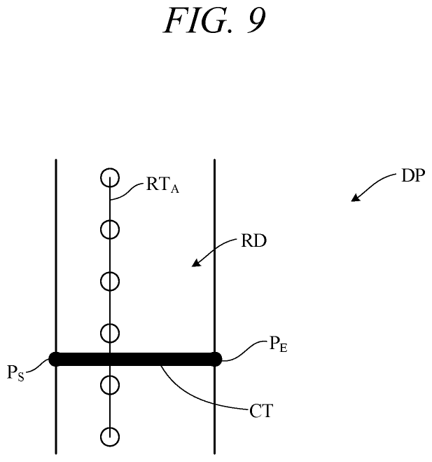

FIG. 9 is a diagram showing placement of a cut icon CT on the display screen DP of the display unit 34 through the input unit 35. In an example in FIG. 9, an actual route RTA obtained by connecting time-series plotted multiple points is displayed on the display screen DP of the display unit 34 so as to be overlaid on a map, for example, on a road RD. When the manager specifies a point PS and a point PE on the map displayed on the display screen DP of the display unit 34 by operating the input unit 35 (e.g., a touchscreen), a line segment-shaped cut icon CT having the point PS as one end and the point PE as another end is drawn, that is, placed. Information on the location of the cut icon CT (the display location, display direction, and size on the map) is transmitted to the management server 2 and stored in the management information area 215. A rectangle having the points PS and PE as a pair of opposite angles may be placed as a cut icon CT, or an ellipse inscribed in a rectangle having the points PS and PE as a pair of opposite angles may be placed as a cut icon CT. The point PS (PE) itself may also be used as a cut icon CT.

The control unit 30 includes a processor including a CPU, RAM, ROM, I/O, and the like. The control unit 30 includes, as functional elements, a display control unit 301, a connection processing unit 302, an evaluation information request unit 303, and a server information acquisition unit 304.

The display control unit 301 controls the screen display of the display unit 34 by generating image signals in accordance with an operation on the input unit 35 and transmitting the image signals to the display unit 34. Screens that the display control unit 301 causes the display unit 34 to display include a login screen for logging in to the management system 100, a setting screen for setting the scheduled routes RTS of the delivery workers A and B, the amounts of work in the blocks BL1 and BL2, the positions of the cut icons CT specifying the start points and end points of the sections SCT1 and SCT2, a route evaluation screen for displaying route evaluation information, and the like.

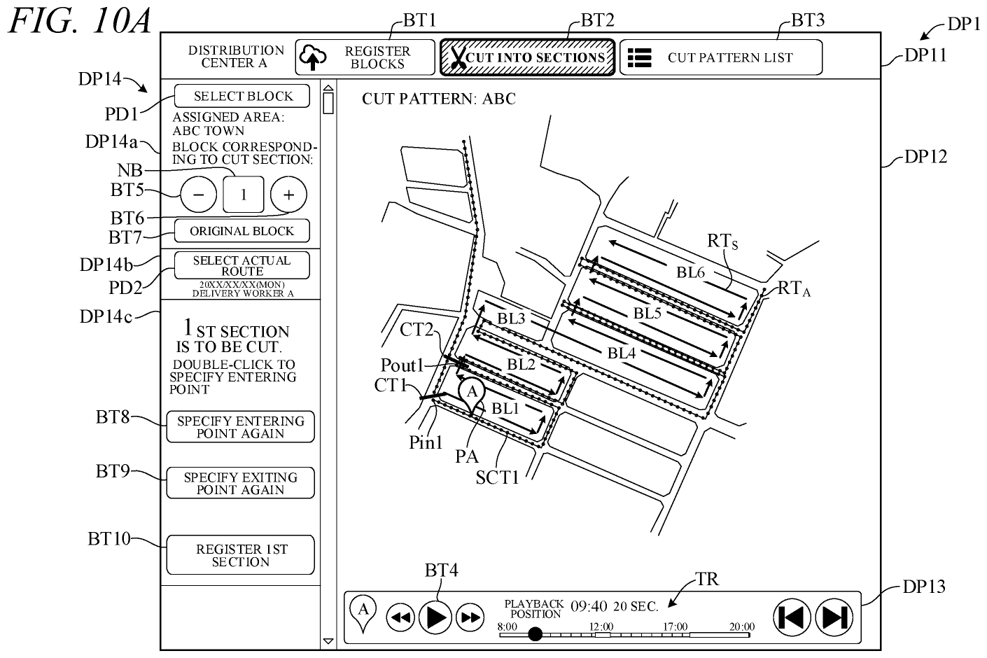

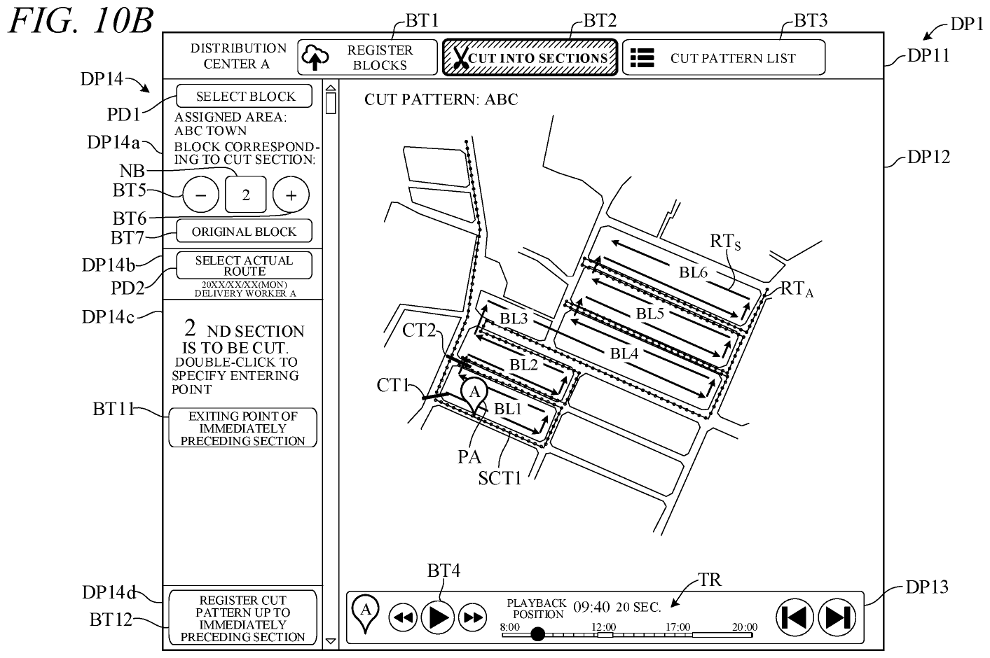

FIGS. 10A and 10B show an example of a setting screen DP1 for setting the positions of cut icons CT specifying the start points and end points of sections. As shown in FIGS. 10A and 10B, the setting screen DP1 displays a main menu DP11, a map display DP12, a playback menu DP13, and a task menu DP14.

The main menu DP11 shows the name of the distribution center (a distribution center A in FIGS. 10A and 10B) on the basis of information on login of the manager. The main menu DP11 also displays selectable main menus (buttons) BT1 to BT3, such as block registration, time-measured section cut, and cut pattern list. When the button BT1 is selected by depressing it, a screen is displayed so that the manager can register a new block or change the range of a registered block thereon. When the button BT2 is selected by depressing it, the setting screen DP1 of FIG. 10A is displayed so that the manager can sequentially place multiple cut icons CT and divide (cut) the actual route RTA into multiple sections on the map display DP12. Information on the positions of the sequentially placed multiple cut icons CT is registered as the time-measured section cut pattern of the actual route RTA, for example, so as to be associated with the assigned area. When the button BT3 is selected by depressing it, a screen having registered cut patterns selectively listed thereon is displayed.

The map display DP12 shows the actual route RTA in a specified delivery period on a map of the area assigned to the delivery worker A specified on the task menu DP14 along with the scheduled route RTS. The map display DP12 also shows, on the actual route RTA, a current location icon PA corresponding to the current location of the delivery worker A at a time specified on the playback menu DP13. Note that the actual route RTA up to the current location on a time-series basis and the actual route RTA following the current location are displayed by plotted points having different colors.

The playback menu DP13 shows a selectable playback button BT 4 for moving the current location icon PA corresponding to the current location of the delivery worker A at a specific time with a lapse of time and other buttons. The playback menu DP13 also shows the time corresponding to the current location as a time display TR. When the playback button BT 4 is selected by depressing it, the time on the time display TR proceeds and the current location icon PA moves (is played back) on the actual route RTA with a lapse of time. During playback, a stop button is shown in place of the playback button BT 4. When the stop button is selected by depressing it, the time on the time display TR stops and the current location icon PA stops on the actual route RTA.

The task menu DP14 shows a block selection menu DP 14a for selecting a block, an actual route selection menu DP 14b for selecting an actual route RTA, a section setting menu DP 14c for setting a section, and a pattern registration menu DP 14d for registering a cut pattern.

The block selection menu DP 14a is used to select a block from blocks which form a scheduled route RTS and whose delivery order is previously set (scheduled delivery order blocks), or a new block (original block). When selecting a block from the scheduled delivery order blocks, a desired area, for example, an area assigned to the delivery worker A, is selected from the previously registered areas through a pulldown menu PD1 and the ordinal number of the desired block in delivery is specified through a button BT5 or BT6. In an example in FIG. 10A, the block BL1 with the first ordinal number in delivery is specified from the six blocks BL1 to BL6 included in the area assigned to the delivery worker A. The specified ordinal number in delivery is shown on a delivery ordinal number display NB. When the button BT6 is depressed, the ordinal number in delivery proceeds to the next block; when the button BT5 is depressed, it returns to the preceding block. Note that when setting a section on the actual route RTA used for delivery in place of the scheduled route RTS, the button BT7 is selected by depressing it and a new block is specified.

The actual route selection menu DP 14b is used to specify a desired delivery period and delivery worker through a pulldown menu PD2. When a delivery period and a delivery worker are specified, a corresponding actual route RTA is shown on the map display DP12.

The section setting menu DP14c is used to specify the start point and end point of a section corresponding to a block specified on the block selection menu DP14a. In the example in FIG. 10A, the start point and end point of the section SCT1 corresponding to the block BL1 that is specified on the block selection menu DP14a and has the first ordinal number in delivery are specified. That is, the cut icon CT1 specifying the start point of the section SCT1 and then the cut icon CT2 specifying the end point of the section SCT1 are placed on the map display DP12. By selecting the buttons BT8 and BT9 by depressing them, the cut icons CT1 and CT2 can be relocated. When the cut icons CT1 and CT2 are placed, the section SCT1 from the plotted start point Pin1 to the plotted end point Pout1 is highlighted and a selectable button BT10 for confirming the section SCT1 is displayed. When the button BT10 is selected by depressing it, the section SCT1 corresponding to the block BL1 with the first ordinal number in delivery is confirmed and information on the positions of the cut icons CT1 and CT2 are registered.

This allows the start point and end point of a section corresponding to the block BL2 with the second ordinal number in delivery to be specified, as shown in FIG. 10B. When specifying the start point of a section corresponding to a block with the second or later ordinal number in delivery, the position of the exit of the immediately preceding section is used by selecting a button BT11 by depressing it. That is, in an example in FIG. 10B, the start point of the section SCT2 is specified by the cut icon CT2 specifying the end point of the section SCT1.

The pattern registration menu DP14d is used to register all the confirmed sections as one cut pattern. Specifically, by confirming all the desired sections, for example, the sections SCT1 to SCT6, and then selecting a button BT12 by depressing it, information on the positions of multiple cut icons CT specifying the sections SCT1 to SCT6 is registered as one cut pattern. When the button BT3 of the main menu DP11 is selected by depressing it, the registered cut patterns are listed.

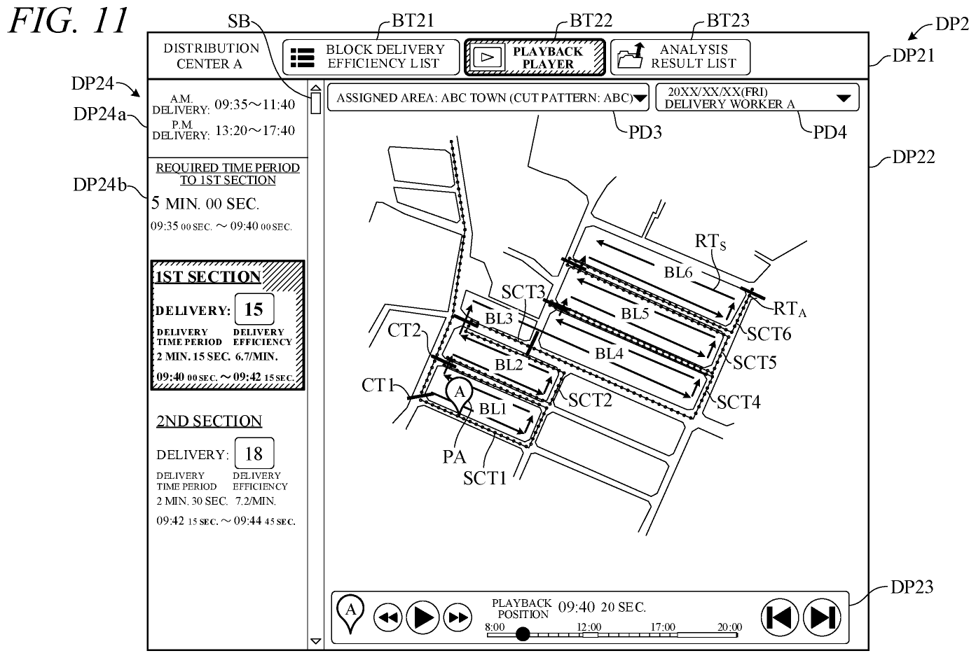

FIG. 11 is an example of a route evaluation screen DP2 showing route evaluation information. As shown in FIG. 11, the route evaluation screen DP2 displays a main menu DP21, a map display DP22, a playback menu DP23, and a route evaluation display DP24.

The main menu DP 21 shows the name of the distribution center on the basis of information on login of the manager. The main menu DP 21 also shows selectable main menus (buttons) BT21 to BT23, such as block delivery efficiency list, playback player, and analysis record list. When the button BT21 is selected by depressing it, a screen having the work efficiency of all the registered blocks listed thereon is displayed. When the button BT22 is selected by depressing it, a route evaluation screen DP2 of FIG. 11 is displayed. When the current location icon PA of the delivery worker A displayed on the map display DP22 is moved using the playback menu DP23, information on the route evaluation of a block corresponding to the current location of the delivery worker A is highlighted on the route evaluation display DP24. When the button BT23 is selected by depressing it, a screen showing an analysis result of route evaluation information is displayed.

The map display DP22 shows a pulldown menu PD3 for selecting a desired area from the areas whose cut patterns have been registered on the setting screen DP1 and a pulldown menu PD4 for specifying a delivery period (the delivery date in FIG. 11) and a delivery worker (the delivery worker A in FIG. 11) whose actual route RTA is desired to be displayed. When a cut pattern and an actual route RTA are specified through the pulldown menus PD3 and PD4, the specified cut pattern and actual route RTA are displayed, as on the map display DP12 of the setting screen DP1 (FIGS. 10A and 10B). Information on the cut pattern specified through the pulldown menu PD3 and the delivery period and delivery worker specified through the pulldown menu PD4 is transmitted from the manager terminal 3 to the management server 2 as a route evaluation information output request. The playback menu DP23 is similar to the playback menu DP13 of the setting screen DPI (FIGS. 10A and 10B).

When the cut pattern, delivery period, and delivery worker are specified through the pulldown menus PD3 and PD4 of the map display DP22 and the route evaluation information output request is transmitted from the manager terminal 3 to the management server 2, the management server 2 calculates the required time periods and work efficiency in the blocks BL1 to BL6. The required time periods and work efficiency in the blocks BL1 to BL6 calculated by the management server 2 are transmitted from the management server 2 to the manager terminal 3 as route evaluation information and displayed on the route evaluation display DP24.

The route evaluation display DP24 shows a work time display DP24a showing the work time of the delivery worker A in the specified delivery period and an evaluation result display DP24b showing a route evaluation about each section.

By moving up and down a scroll bar SB through the input unit 35 (touchscreen), route evaluations about all the sections, for example, the sections SCT1 to SCT6 corresponding to the blocks BL1 to BL6, are displayed. In addition to the route evaluations about the sections SCT1 to SCT6, the evaluation result display DP24b also shows the time period required to travel from the distribution center to the first section SCT1 and the time period required to travel from the last section (e.g., the sixth section) SCT6 to the distribution center. The evaluation result display DP24b also shows the time period required to travel from one delivery section to the next delivery section.

In an example in FIG. 11, the current location icon PA of the delivery worker A displayed on the map display DP22 is located in the first section SCT1 and therefore the route evaluation about the first section SCT1 is highlighted on the route evaluation display DP24. The number of pieces delivered and the delivery time period in the block BL1 corresponding to the section SCT1, as well as the delivery efficiency therein is displayed as the route evaluation about the first section SCT1. The route evaluation display DP24 also shows the time slot in which the delivery worker has stayed in the section SCT1. The route evaluations about the second to sixth sections SCT2 to SCT6 are displayed as well.

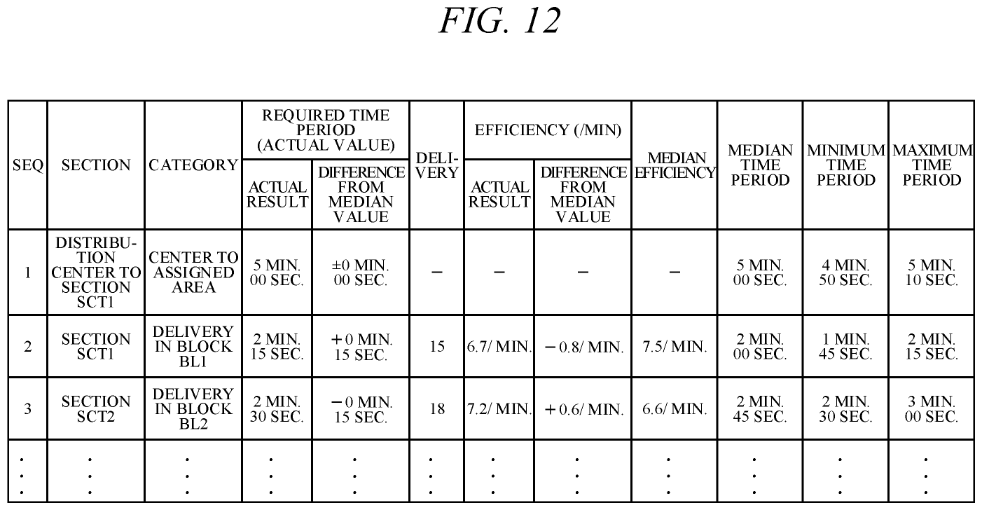

FIG. 12 shows an example of analysis results of route evaluation information displayed when the button BT23 is selected on the main menu DP21 of the route evaluation screen DP2 and shows the actual performance of the specified delivery worker in the specified delivery period for each travel section. As shown in FIG. 12, the actual time and actual efficiency in the specified delivery period, as well as the median value and the difference between the median value and actual value in the data accumulation period (e.g., in each month) are displayed as the analysis results of the route evaluation information. The manager of the distribution center is able to relatively evaluate the delivery time period and delivery efficiency of the specified delivery worker in the specified delivery period by viewing the analysis results of the route evaluation information. Thus, the manager is able to review the delivery workers in charge of the respective blocks or the scheduled routes on the respective days of the week or in the respective time slots.

The connection processing unit 302 (FIG. 8) processes login to the management server 2 using, for example, an identification number for identifying the manager or responsible person of the distribution center (center manager ID) and a password.

The evaluation information request unit 303 specifies a delivery worker and a delivery period in accordance with an operation on the input unit 35 by the manager and transmits a route evaluation information output request to the management server 2.

The server information acquisition unit 304 acquires route evaluation information or the like transmitted from the management server 2 (information output unit 207). Thus, the route evaluation screen DP2 (FIG. 11) or the analysis results of the route evaluation information (FIG. 12) is displayed on the display unit 34.

### [Operation of Management System 100]

Next, an example of the operation of the management system 100 will be described. For example, when departing from the distribution center, that is, when starting work, the delivery worker A who drives the vehicle 6A inputs his or her login ID and a password on the login screen displayed on the display unit 14 of the delivery worker terminal 1A through the input unit 15. Thus, the management server 2 processes connection from the delivery worker terminal 1A. Subsequently, the delivery worker terminal 1A communicates with the management server 2 at predetermined time intervals (e.g., at intervals of 1 s), for example, transmits information on the location of the delivery worker A or vehicle 6A to the management server 2. The communication between the delivery worker terminal 1A and management server 2 continues until the delivery worker terminal 1A logs out.

On the other hand, the manager of the distribution center inputs the center manager ID and a password on the login screen displayed on the display unit 34 of the manager terminal 3 through the input unit 35. Thus, the management server 2 processes connection from the manager terminal 3. When the manager specifies the delivery worker A and a delivery period through the input unit 35 (touchscreen), the scheduled route RTS and actual route RTA of the delivery worker A in the specified delivery period are displayed on the display unit 34 (FIG. 4). The manager places the cut icon CT1 specifying the start point of the section SCT1 corresponding to the block BL1 and the cut icon CT2 specifying the end point thereof on the actual route RTA through the input unit 35 (touchscreen) (FIG. 5).

In response to this input, the management server 2 selects the plotted start point Pin and plotted end point Pout of the specified section SCT1 and calculates the required time period and work efficiency in the section SCT1 (steps S1 to S5). Also, when the sections corresponding to all the blocks assigned to the delivery worker A are specified, the management server 2 determines whether the scheduled route RTS and actual route RTA match each other (step S6). Information on the required time period and work efficiency in the section SCT1 and the determination as to whether the scheduled route RTS and actual route RTA match each other calculated by the management server 2 is transmitted to the manager terminal 3 as route evaluation information. Thus, the route evaluation screen DP2 (FIG. 11) or analysis results of the route evaluation information (FIG. 12) are displayed on the display unit 34 (step S7).

Through the manager terminal 3, the manager of the distribution center is able to check the required time period and work efficiency in the block BL1 and whether the scheduled route RTS and actual route RTA match each other and to evaluate the travel routes of the delivery worker A, that is, the actual route RTA and scheduled route RTS thereof. The manager is also able to review the range of the block BL1, the scheduled route RTS, or the like in accordance with the evaluation of the travel routes and thus to improve the efficiency of the delivery work of the delivery worker A. The manager is also able to make a comparison between the evaluations of the travel routes of the multiple delivery workers A and B belonging to the distribution center, to review the delivery worker in charge of the blocks BL1 and BL2 when necessary, and thus to improve the efficiency of delivery work of the entire distribution center.

The present embodiment can achieve advantages and effects such as the following:

(1) The route evaluation apparatus 5 is configured to evaluate the travel route of the delivery worker A, B who conducts delivery work. The route evaluation apparatus 5 includes: the information acquisition unit 202 configured to acquire the location information of the delivery worker a, B calculated based on GPS signals received by the GPS sensor 13a provided on the delivery worker terminal 1A, 1B carried by the delivery worker A, B, and configured to acquire the time information about when the location information is calculated; the display unit 34 configured to display the plurality of plotted points corresponding to the location information based on the location information and the time information acquired by the information acquisition unit 202; the input unit 35 (touchscreen) configured to place the cut icons CT1, CT2 on the actual route RTA connecting plotted points next to each other in timing from among the plurality of plotted points displayed by the display unit 34; the start point/end point selection unit 203 configured to select the plotted start point Pin corresponding to the cut icon CT1 placed by the input unit 35 (touchscreen), and configured to select the plotted end point Pout corresponding to the cut icon CT2 placed by the input unit 35 from among the plurality of plotted points; and the required time calculation unit 204 configured to calculate a required time period for the section SCT1, SCT2 from the plotted start point Pin to the plotted end point Pout selected by the start point/end point selection unit 203 (FIG. 3, FIG. 8). This configuration allows the manager of the distribution center to specify the specific sections SCT1 and SCT2 of the travel routes, particularly, the actual route RTA of the delivery worker A or B, to calculate the required time periods, and to evaluate the travel routes.

(2) The start point/end point selection unit 203 is configured to select a plotted point nearest in distance to the cut icon CT1 placed by the input unit 35 (touchscreen) as the plotted start point Pin, and is configured to select a plotted point nearest in distance the cut icon CT2 placed by the input unit 35 (touchscreen) as the plotted end point Pout. With this, the manager of the distribution center is able to specify the desired sections SCT1 and SCT2 with a simple, intuitive operation of simply placing the cut icons CT (CT1 and CT2) on the actual route RTA displayed on the display unit 34.

(3) The input unit 35 (touchscreen) is configured to place the cut icon CT1 as a line segment or an area crossing the actual route RTA, and is configured to place the cut icon CT2 as a line segment or an area crossing the actual route RTA. With this, the manager of the distribution center is able to specify the desired sections SCT1 and SCT2 with an intuitive operation as if the manager cut the sections SCT1 and SCT2 from the actual route RTA displayed on the manager terminal 34 using scissors.

(4) The route evaluation apparatus 5 further includes: the storage unit 21 (management information area 215) configured to store the information on the positions of the cut icon CT1 and the cut icon CT2 (FIG. 3). With this, the route evaluation apparatus 5 is able to read and use information on the locations of the cut icons CT specifying the sections SCT1 and SCT2.

(5) The travel route sequentially passes through a plurality of predetermined blocks BL1, BL2 in a predetermined passing order (FIG. 4, FIG. 5). The input unit 35 (touchscreen) is configured to place a plurality of cut icons CT on each entering points of the plurality of blocks BL1, BL2, and is configured to place a plurality of cut icons CT on each exiting points of the plurality of blocks BL1, BL2 (FIG. 5 to FIG. 6B). The required time calculation unit 204 is configured to calculate the required time period for each of a plurality of sections SCT1, SCT2 corresponding to the plurality of blocks BL1, BL2 in the delivery order. With this, the manager is able to grasp the required time periods in the blocks BL1 and BL2 with respect to the entire actual route that sequentially passes through the multiple blocks BL1 and BL2 and to review the scheduled route RTS that sequentially passes through the multiple blocks BL1 and BL2, when necessary.

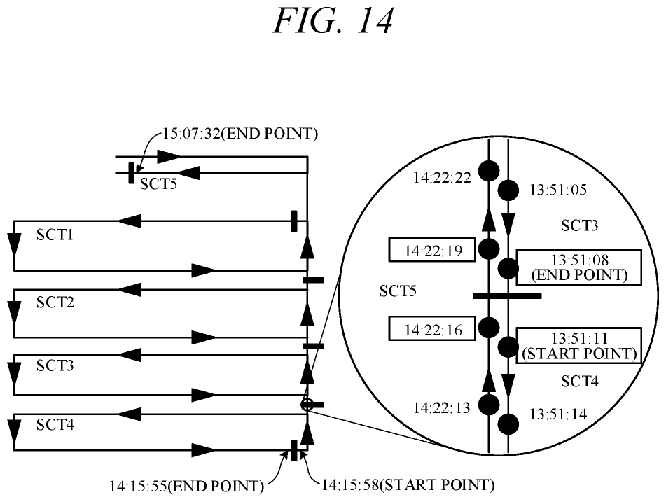

(6) The start point/end point selection unit 203 is configured to select from among the plurality of plotted points a plotted point behind in timing than the plotted end point Pout1, Pout2 of the section SCT1, SCT2 immediately preceding in the predetermined passing order and nearest in timing to the plotted end point Pout1, Pout2 of the section SCT1, SCT2 immediately preceding in the predetermined passing order as the plotted start point Pin2, Pin3 of the section SCT2, SCT3 immediately after in the predetermined passing order (FIG. 5 to FIG. 6B). The time-measured sections are along the order of delivery. For this reason, even if the required time period in a section corresponding to a specific block is measured and then the delivery worker passes through the block a number of times on that day, the measured required time period is not affected. For example, even if the delivery worker travels the sections SCT1 to SCT4 corresponding to the blocks BL1 to BL4 and then passes through the blocks BL1 to BL4 as shown in FIG. 14, the measured required time periods in the sections SCT1 to SCT4 are not affected.

(7) The information acquisition unit 202 is configured to further acquire information about the amount of work predetermined for each of the plurality of blocks BL1, BL2. The route evaluation apparatus 5 further includes: the work efficiency calculation unit 205 configured to calculate the work efficiency in each of the plurality of blocks BL1, BL2 based on the required time period of each of the plurality of sections SCT1, SCT2 corresponding to the plurality of blocks BL1, BL2 calculated by the required time calculation unit 204 and the information about the amount of work predetermined for each of the plurality of blocks BL1, BL2 acquired by the information acquisition unit 202 (FIG. 3). With this, the manager is able to evaluate the actual route RTA by checking the work efficiency in each of the blocks BL1 and BL2.

(8) The information acquisition unit 202 is configured to further acquire information about the scheduled order for passing through the plurality of predetermined blocks BL1, BL2. The route evaluation apparatus 5 further includes: the matching determination unit configured to determine whether the actual order (actual route RTA) in which the delivery worker A, B actually passes through the plurality of blocks BL1, BL2 and the scheduled order (scheduled route RTS) match each other based on the location information, the time information, and the information about the scheduled order acquired by the information acquisition unit 202 (FIG. 3). With this, the manager is able to evaluate the scheduled route RTS by checking whether the scheduled route RTS and actual route RTA match each other.

(9) The information acquisition unit 202 is configured to further acquire information about the scheduled route RTS of the delivery worker A, B. The display unit 34 is configured to further display the scheduled route RTS acquired by the information acquisition unit 202 (FIG. 10A to FIG. 11). With this, the manager is able to grasp whether the delivery worker A or B has used the scheduled route RTS and to review the scheduled route RTS when necessary.

The above-mentioned embodiment can be modified into various forms. Hereafter, modifications will be described. While, in the above embodiment, an example in which the route evaluation apparatus 5 evaluates the travel routes of the delivery workers has been described, the route evaluation apparatus is not limited to this example as long as it evaluates the travel routes of workers in charge of work.

While, in the above embodiment, the GPS sensors 13a are mounted on the delivery worker terminals 1A and 1B carried by the delivery workers A and B, the GPS sensors may be of any type as long as they are disposed on mobile terminals carried by the workers in charge or disposed on moving bodies driven by the workers in charge.

While, in the above embodiment, the information acquisition unit 202 acquires information on the locations calculated by the delivery worker terminals 1A and 1B, the information acquisition unit that acquires information on the locations of the workers in charge and information on the times at which the locations have been calculated may be configured otherwise. For example, the management server 2 may calculate the locations on the basis of GPS signals received by the delivery worker terminals 1A and 1B.

While, in the above embodiment, the cut icons CT are placed through the input unit 35 (touchscreen) of the manager terminal 3, the icon placement unit that places first and second icons on the travel route may be configured otherwise. For example, the display positions of the cut ions may be moved in conjunction with an operation on a mouse, numeric pad, or the like by the manager. Coordinate values or the like corresponding to the display positions of the cut icons may be directly inputted.

While, in the above embodiment, information on the display positions on a map of the cut icons CT is stored in the management information area 215 of the storage unit 21, the storage unit that stores information on a first line segment or first area and a second line segment or second area may be configured otherwise. For example, the storage unit may store information on the latitude and longitude on a map at which the cut icons are displayed.

The above description is only an example, and the present invention is not limited to the above embodiment and modifications, unless impairing features of the present invention. The above embodiment can be combined as desired with one or more of the above modifications. The modifications can also be combined with one another.

### REFERENCE SIGNS LIST

1A, 1B delivery worker terminal, 2 management server, 3 manager terminal, 4 network, 5 route evaluation apparatus, 6A, 6B vehicle, 10 control unit, 11 storage unit, 12 wireless unit, 13 sensor unit, 13a GPS sensor, 13b gyro sensor, 14 display unit, 15 input unit, 20 control unit, 21 storage unit, 22 communication unit, 24 display unit, 25 input unit, 30 control unit, 31 storage unit, 32 communication unit, 34 display unit, 35 input unit, 100 management system, 101 display control unit, 102 connection processing unit, 103 location information notification unit, 104 speed information notification unit, 201 connection processing unit, 202 information acquisition unit, 203 start point/end point selection unit, 204 required time calculation unit, 205 work efficiency calculation unit, 206 matching determination unit, 207 information output unit, 211 delivery worker information area, 212 vehicle information area, 213 delivery destination information area, 214 map information area, 215 management information area, 301 display control unit, 302 connection processing unit, 303 evaluation information request unit, 304 server information acquisition unit, DP display screen, DP1 setting screen, DP2 route evaluation screen.

1. A route evaluation apparatus configured to evaluate a travel route of a worker who conducts business or work, comprising:
a microprocessor and a memory coupled to the microprocessor, wherein
the microprocessor is configured to function as:
an information acquisition unit configured to acquire location information of the worker calculated based on GPS signals received by a GPS receiver provided on a mobile terminal carried by the worker or provided on a mobile body driven by the worker, and configured to acquire time information about when the location information is calculated, wherein
the route evaluation apparatus further comprises:
a display unit configured to display a plurality of plotted points corresponding to the location information based on the location information and the time information acquired by the information acquisition unit; and
an icon placement unit configured to place a first icon and a second icon on the travel route connecting plotted points next to each other in timing from among the plurality of plotted points displayed by the display unit, wherein
the microprocessor is configured to function as:
a start point/end point selection unit configured to select a start point corresponding to the first icon placed by the icon placement unit, and configured to select an end point corresponding to the second icon placed by the icon placement unit from among the plurality of plotted points; and
a required time calculation unit configured to calculate a required time period for a section from the start point to the end point selected by the start point/end point selection unit, wherein
the travel route sequentially passes through a plurality of predetermined areas in a predetermined passing order, wherein
the icon placement unit is configured to place a plurality of the first icon on each entering points of the plurality of predetermined areas, and is configured to place a plurality of the second icon on each exiting points of the plurality of predetermined areas, wherein
the required time calculation unit is configured to calculate the required time period for each of a plurality of the section corresponding to the plurality of predetermined areas.

2. The route evaluation apparatus according to claim 1, wherein
the start point/end point selection unit is configured to select a plotted point nearest in distance to the first icon placed by the icon placement unit as the start point, and is configured to select a plotted point nearest in distance to the second icon placed by the icon placement unit as the end point.

3. The route evaluation apparatus according to claim 1, wherein
the icon placement unit is configured to place the first icon as a first line segment or a first area crossing the travel route, and is configured to place the second icon as a second line segment or a second area crossing the travel route.

4. The route evaluation apparatus according to claim 3, wherein
the memory is configured to store information about the first line segment or the first area and the second line segment or the second area.

5. (canceled)

6. The route evaluation apparatus according to claim 1, wherein
the start point/end point selection unit is configured to select from among the plurality of plotted points a plotted point behind in timing than the end point of the section immediately preceding in the predetermined passing order and nearest in timing to the end point of the section immediately preceding in the predetermined passing order as the start point of the section immediately after in the predetermined passing order.

7. The route evaluation apparatus according to claim 1, wherein
the information acquisition unit is configured to further acquire information about an amount of business or work predetermined for each of the plurality of predetermined areas, wherein
the microprocessor is configured to function as:
a work efficiency calculation unit configured to calculate a business efficiency or a work efficiency in each of the plurality of predetermined areas based on the required time period of each of the plurality of the section corresponding to the plurality of predetermined areas calculated by the required time calculation unit and the information about the amount of business or work predetermined for each of the plurality of predetermined areas acquired by the information acquisition unit.

8. The route evaluation apparatus according to claim 1, wherein
the information acquisition unit is configured to further acquire information about a scheduled order for passing through the plurality of predetermined areas, wherein
the microprocessor is configured to function as:
a matching determination unit configured to determine whether an actual order in which the worker actually passes through the plurality of predetermined areas and the scheduled order match each other based on the location information, the time information, and the information about the scheduled order acquired by the information acquisition unit.

9. The route evaluation apparatus according to claim 1, wherein
the information acquisition unit is configured to further acquire information about a scheduled route of the worker, wherein
the display unit is configured to further display the scheduled route acquired by the information acquisition unit.

10. A route evaluation apparatus configured to evaluate a travel route of a worker who conducts business or work, comprising:
a microprocessor and a memory coupled to the microprocessor, wherein
the microprocessor is configured to perform:
acquiring location information of the worker calculated based on GPS signals received by a GPS receiver provided on a mobile terminal carried by the worker or provided on a mobile body driven by the worker, and acquiring time information about when the location information is calculated, wherein
the route evaluation apparatus further comprises:
a display unit configured to display a plurality of plotted points corresponding to the location information based on the location information and the time information acquired by the information acquisition unit; and
an icon placement unit configured to place a first icon and a second icon on the travel route connecting plotted points next to each other in timing from among the plurality of plotted points displayed by the display unit, wherein
the microprocessor is configured to perform:
selecting a start point corresponding to the first icon placed by the icon placement unit, and selecting an end point corresponding to the second icon placed by the icon placement unit from among the plurality of plotted points; and
calculating a required time period for a section from the start point to the end point selected in the selecting, wherein
the travel route sequentially passes through a plurality of predetermined areas in a predetermined passing order, wherein
the icon placement unit is configured to place a plurality of the first icon on each entering points of the plurality of predetermined areas, and is configured to place a plurality of the second icon on each exiting points of the plurality of predetermined areas, wherein
the microprocessor is configured to perform:
the calculating including calculating the required time period for each of a plurality of the section corresponding to the plurality of predetermined areas.

11. The route evaluation apparatus according to claim 10, wherein
the microprocessor is configured to perform:
the selecting including selecting a plotted point nearest in distance to the first icon placed by the icon placement unit as the start point, and selecting a plotted point nearest in distance to the second icon placed by the icon placement unit as the end point.

12. The route evaluation apparatus according to claim 10, wherein
the icon placement unit is configured to place the first icon as a first line segment or a first area crossing the travel route, and is configured to place the second icon as a second line segment or a second area crossing the travel route.

13. The route evaluation apparatus according to claim 12, wherein the memory is configured to store information about the first line segment or the first area and the second line segment or the second area.

14. The route evaluation apparatus according to claim 10, wherein
the microprocessor is configured to perform:
the selecting including selecting from among the plurality of plotted points a plotted point behind in timing than the end point of the section immediately preceding in the predetermined passing order and nearest in timing to the end point of the section immediately preceding in the predetermined passing order as the start point of the section immediately after in the predetermined passing order.

15. The route evaluation apparatus according to claim 10, wherein
the microprocessor is configured to perform:
the acquiring including acquiring information about an amount of business or work predetermined for each of the plurality of predetermined areas, wherein the microprocessor is configured to perform:
calculating a business efficiency or a work efficiency in each of the plurality of predetermined areas based on the required time period of each of the plurality of the section corresponding to the plurality of predetermined areas calculated and the information about the amount of business or work predetermined for each of the plurality of predetermined areas acquired in the acquiring.

16. The route evaluation apparatus according to claim 10, wherein
the microprocessor is configured to perform:
the acquiring including acquiring information about a scheduled order for passing through the plurality of predetermined areas, wherein
the microprocessor is configured to perform:
determining whether an actual order in which the worker actually passes through the plurality of predetermined areas and the scheduled order match each other based on the location information, the time information, and the information about the scheduled order acquired in the acquiring.

17. The route evaluation apparatus according to claim 10, wherein
the microprocessor is configured to perform:
the acquiring including acquiring information about a scheduled route of the worker, wherein
the display unit is configured to further display the scheduled route acquired in the acquiring.
